(19) United States
(12) Patent Application Publication
(10) Pub. No.: US 2026/0291733 A1
(43) Pub. Date: Sep. 24, 2026

(54) ENCRYPTION SYSTEM, ENCRYPTION METHOD, AND COMPUTER READABLE MEDIUM

(71) Applicant: Mitsubishi Electric Corporation, Tokyo (JP)

(72) Inventor: Yutaka KAWAI, Tokyo (JP)

(73) Assignee: Mitsubishi Electric Corporation, Tokyo (JP)

(21) Appl. No.: 19/455,435

(22) Filed: Jan. 21, 2026

Related U.S. Application Data
(63) Continuation of application No. PCT/JP2023/032063, filed on Sep. 1, 2023.

(51) Int. Cl. H04L 9/16; H04L 9/08

(52) U.S. Cl. CPC H04L 9/16; H04L 9/0869

(57) ABSTRACT

An encrypting device (400) generates a ciphertext by doubly encrypting a plaintext using a first internal public key and a first external public key. A re-encryption key generation device (500) generates a randomized internal secret key using a first internal secret key, generates a second encrypted random number using a second internal public key, generates a randomized external secret key using a first external secret key, and generates a first encrypted random number using a second external public key. A re-encrypting device (600) generates a re-encrypted text using the randomized external secret key, the randomized internal secret key, the second internal public key, the second external public key, and the ciphertext. A decryption device (700) calculates the plaintext using the second internal secret key, the second encrypted random number, the second external secret key, the first encrypted random number, and the re-encrypted text.

### CROSS REFERENCE TO RELATED APPLICATIONS

This application is a Continuation of PCT International Application No. PCT/JP2023/032063 filed on Sep. 1, 2023, all of which is hereby expressly incorporated by reference into the present application.

### DESCRIPTION

### Technical Field

The present disclosure relates to a method of re-encrypting a ciphertext without decrypting the ciphertext.

### Background Art

Proxy re-encryption is a public key encryption technology that enables a ciphertext to be modified into a new ciphertext with a different key without decrypting the original ciphertext.

Non-Patent Literature 1 discloses a public key encryption method that realizes the proxy re-encryption.

Further, a method has been proposed in which the proxy re-encryption is realized even when an encryption method is different.

### CITATION LIST

### Non-Patent Literature

Non-Patent Literature 1: Achieving Flexibility for ABE with Outsourcing via Proxy Re-Encryption, Asiaccs'18, Jun. 4-8, 2018, Incheon, Republic of Korea

### SUMMARY OF INVENTION

### Technical Problem

Non-Patent Literature 1 indicates a method of modifying a key while keeping the key encrypted. Further, Non-Patent Literature 1 indicates that conversion to a different encryption method is possible when a certain characteristic is present.

However, Non-Patent Literature 1 does not mention a method of handling double encryption.

The present disclosure aims to enable to modify a key for an internal encryption method while leaving a key for an external encryption method unmodified, in double encryption.

### Solution to Problem

An encryption system according to the present disclosure includes:
an encrypting device to generate a ciphertext by double encrypting a plaintext using a first internal public key and a first external public key;
a re-encryption key generation device to generate a randomized internal secret key by randomizing a first internal secret key using a second random number, to generate a second encrypted random number by encrypting the second random number using a second internal public key, to generate a randomized external secret key by randomizing a first external secret key using a first random number, and to generate a first encrypted random number by encrypting the first random number using a second external public key;
a re-encrypting device to obtain a randomized decryption text by decrypting the ciphertext using the randomized external secret key and the randomized internal secret key, and to generate a re-encrypted text by encrypting the randomized decryption text using the second internal public key and the second external public key; and
a decryption device to decrypt the second random number from the second encrypted random number using the second internal secret key, to decrypt the first random number from the first encrypted random number using the second external secret key, to decrypt the randomized decryption text from the re-encrypted text using the second external secret key and the second internal secret key, and to calculate the plaintext using the randomized decryption text, the second random number, and the first random number.

### Advantageous Effects of Invention

According to the present disclosure, it is possible to modify a key for an internal encryption method while leaving a key for an external encryption method unmodified, in double encryption.

### BRIEF DESCRIPTION OF DRAWINGS

FIG. 1 is a configuration diagram of an encryption system 100 in Embodiment 1.

FIG. 2 is a configuration diagram of a parameter generation device 200 in Embodiment 1.

FIG. 3 is a configuration diagram of a key generation device 300 in Embodiment 1.

FIG. 4 is a configuration diagram of an encrypting device 400 in Embodiment 1.

FIG. 5 is a configuration diagram of a re-encryption key generation device 500 in Embodiment 1.

FIG. 6 is a configuration diagram of a re-encrypting device 600 in Embodiment 1.

FIG. 7 is a configuration diagram of a decryption device 700 in Embodiment 1.

FIG. 8 is a diagram of a functional configuration of the parameter generation device 200 in Embodiment 1.

FIG. 9 is a flowchart of a parameter generation method in Embodiment 1.

FIG. 10 is a diagram of a functional configuration of the key generation device in Embodiment 1.

FIG. 11 is a flowchart of a key generation method in Embodiment 1.

FIG. 12 is a diagram of a functional configuration of the encrypting device 400 in Embodiment 1.

FIG. 13 is a flowchart of an encrypting method in Embodiment 1.

FIG. 14 is a diagram of a functional configuration of the re-encryption key generation device 500 in Embodiment 1.

FIG. 15 is a flowchart of a re-encryption key generation method in Embodiment 1.

FIG. 16 is a diagram of a functional configuration of the re-encrypting device in Embodiment 1.

FIG. 17 is a flowchart of a re-encrypting method in Embodiment 1.

FIG. 18 is a diagram of a functional configuration of the decryption device 700 in Embodiment 1.

FIG. 19 is a flowchart of a decryption method in Embodiment 1.

FIG. 20 is a diagram of a hardware configuration of the parameter generation device 200 in Embodiment 1.

FIG. 21 is a diagram of a hardware configuration of the key generation device 300 in Embodiment 1.

FIG. 22 is a diagram of a hardware configuration of the encrypting device in Embodiment 1.

FIG. 23 is a diagram of a hardware configuration of the re-encryption key generation device 500 in Embodiment 1.

FIG. 24 is a diagram of a hardware configuration of the re-encrypting device 600 in Embodiment 1.

FIG. 25 is a diagram of a hardware configuration of the decryption device 700 in Embodiment 1.

### DESCRIPTION OF EMBODIMENTS

In the Embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

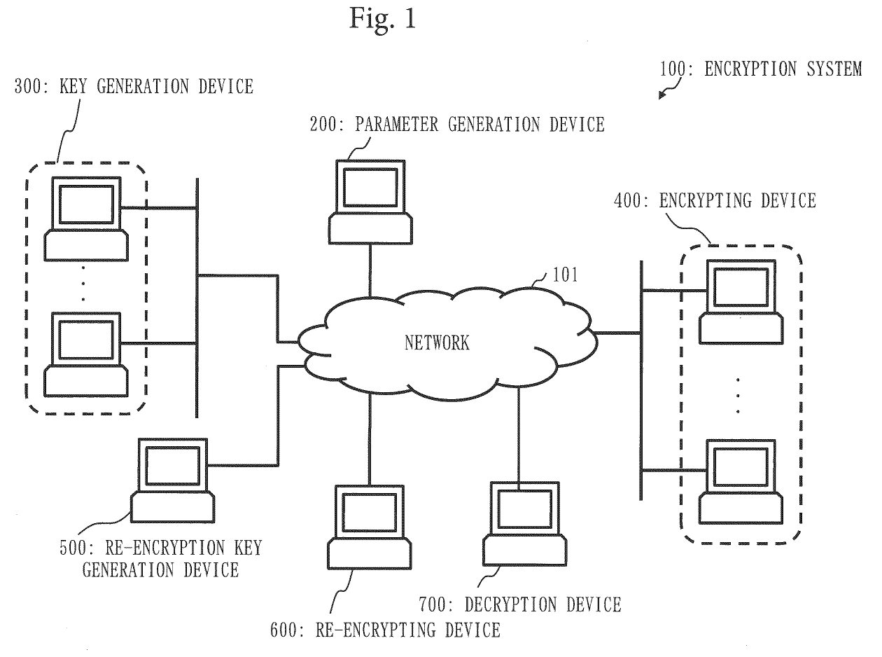

An encryption system 100 will be described based on FIGS. 1 to 25.

### Description of Configuration

A configuration of the encryption system 100 will be described based on FIG. 1.

The encryption system 100 includes a parameter generation device 200, a plurality of key generation devices 300, a plurality of encrypting devices 400, a re-encryption key generation device 500, a re-encrypting device 600, and a decryption device 700.

These devices communicate with one another through a network 101. The network 101 is a communication path that connects these devices. An example of the network 101 is the Internet. When the encryption system 100 is installed in a company, a local area network (LAN) may be used as the network 101, for example. Other types of the network 101 may also be used.

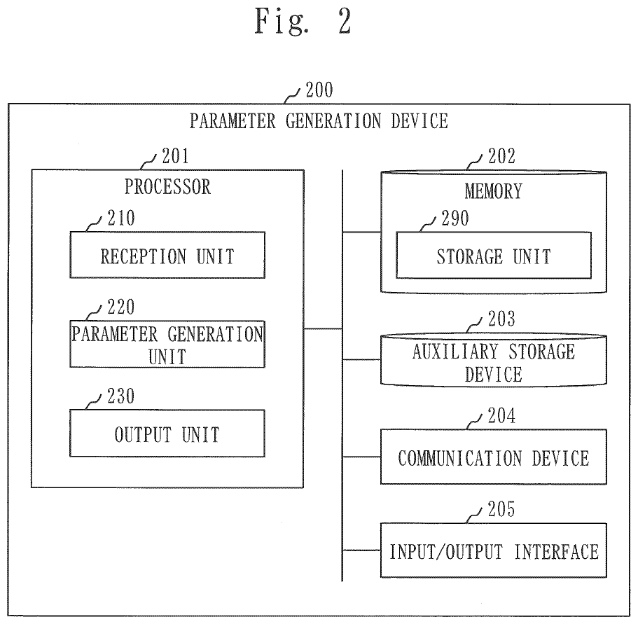

A configuration of the parameter generation device 200 will be described based on FIG. 2.

The parameter generation device 200 is a computer that includes pieces of hardware such as a processor 201, a memory 202, an auxiliary storage device 203, a communication device 204, and an input/output interface 205. These pieces of hardware are connected with one another through signal lines.

The processor is an IC that performs arithmetic processing, and controls other pieces of hardware. The processor is, for example, a CPU.

IC is an abbreviation for Integrated Circuit.

CPU is an abbreviation for Central Processing Unit.

The memory is a volatile or non-volatile storage device. The memory is also referred to as a main storage device or a main memory. The memory is, for example, an RAM. Data stored in the memory is saved in the auxiliary storage device as necessary.

RAM is an abbreviation for Random Access Memory.

The auxiliary storage device is a non-volatile storage device. The auxiliary storage device is, for example, an ROM, an HDD, a flash memory, or a combination of these. Data stored in the auxiliary storage device is loaded into the memory as necessary.

ROM is an abbreviation for Read Only Memory.

HDD is an abbreviation for Hard Disk Drive.

Communication of the parameter generation device 200 is performed using the communication device 204.

The communication device is a receiver and a transmitter. The communication device is, for example, a communication chip or an NIC.

NIC is an abbreviation for Network Interface Card.

Input and output of the parameter generation device 200 is performed using the input/output interface 205.

The input/output interface is a port to which an input device and an output device are connected. The input/output interface is a USB terminal, the input device is a keyboard or a mouse, and the output device is a display, for example.

USB is an abbreviation for Universal Serial Bus.

The parameter generation device 200 includes elements such as a reception unit 210, a parameter generation unit 220, and an output unit 230. These elements are implemented by software.

The auxiliary storage device stores an OS. At least a part of the OS is loaded into the memory and executed by the processor.

The auxiliary storage device 203 further stores a parameter generation program for causing the computer to function as the reception unit 210, the parameter generation unit 220, and the output unit 230. The parameter generation program is loaded into the memory 202 and executed by the processor 201.

While executing the OS, the processor 201 executes the parameter generation program.

OS is an abbreviation for Operating System.

Input and output data of the parameter generation program is stored in a storage unit 290.

The memory functions as the storage unit. However, storage devices such as the auxiliary storage device, a register in the processor, and a cache memory in the processor may also function as the storage unit instead of the memory or together with the memory.

The parameter generation program can be recorded (stored) in a non-volatile recording medium such as an optical disc or a flash memory, in a computer readable format.

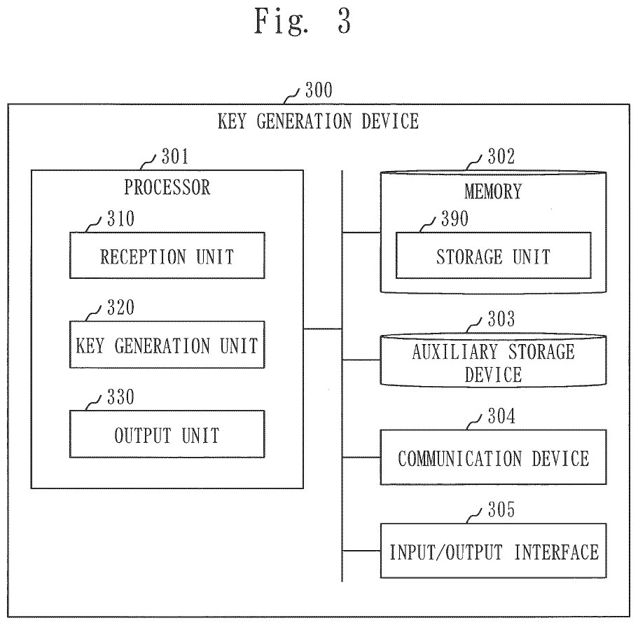

A configuration of the key generation device 300 will be described based on FIG. 3.

The key generation device 300 is a computer that includes pieces of hardware such as a processor 301, a memory 302, an auxiliary storage device 303, a communication device 304, and an input/output interface 305. These pieces of hardware are connected with one another through signal lines.

Communication of the key generation device 300 is performed using the communication device 304.

Input and output of the key generation device 300 is performed using the input/output interface 305.

The key generation device 300 includes elements such as a reception unit 310, an internal key generation unit 321, an external key generation unit 322, and an output unit 330. These elements are implemented by software.

The auxiliary storage device 303 stores a key generation program for causing the computer to function as the reception unit 310, the internal key generation unit 321, the external key generation unit 322, and the output unit 330. The key generation program is loaded into the memory 302 and executed by the processor 301.

While executing the OS, the processor 301 executes the key generation program.

Input and output data of the key generation program is stored in a storage unit 390.

The key generation program can be recorded (stored) in a non-volatile recording medium such as an optical disc or a flash memory, in a computer readable format.

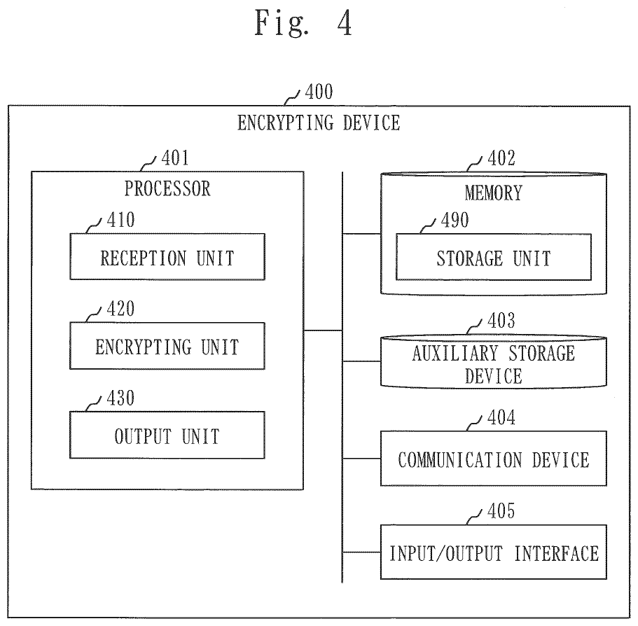

A configuration of the encrypting device 400 will be described based on FIG. 4.

The encrypting device 400 is a computer that includes pieces of hardware such as a processor 401, a memory 402, an auxiliary storage device 403, a communication device 404, and an input/output interface 405. These pieces of hardware are connected with one another through signal lines.

Communication of the encrypting device 400 is performed using the communication device 404.

Input and output of the encrypting device 400 is performed using the input/output interface 405.

The encrypting device 400 includes elements such as a reception unit 410, an encrypting unit 420, and an output unit 430. These elements are implemented by software.

The auxiliary storage device 403 stores an encrypting program for causing the computer to function as the reception unit 410, the encrypting unit 420, and the output unit 430. The encrypting program is loaded into the memory 402 and executed by the processor 401.

While executing the OS, the processor 401 executes the encrypting program.

Input and output data of the encrypting program is stored in a storage unit 490.

The encrypting program can be recorded (stored) in a non-volatile recording medium such as optical disc or a flash memory, in a computer readable format.

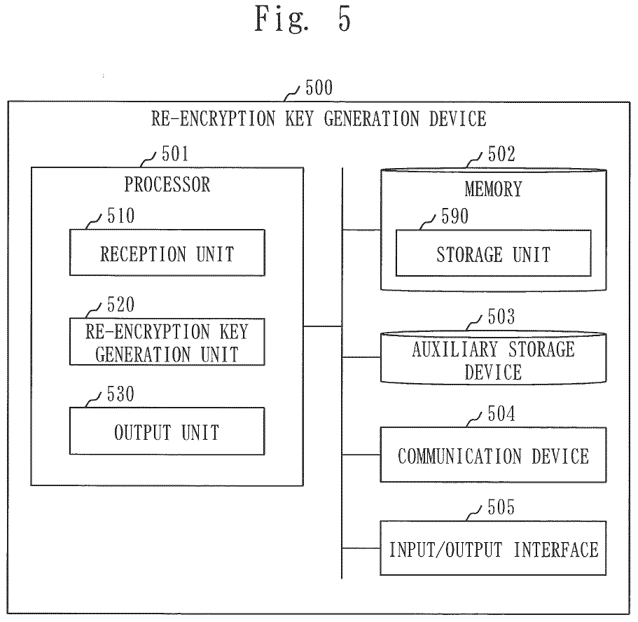

A configuration of the re-encryption key generation device 500 will be described based on FIG. 5.

The re-encryption key generation device 500 is a computer that includes pieces of hardware such as a processor 501, a memory 502, an auxiliary storage device 503, a communication device 504, and an input/output interface 505. These pieces of hardware are connected with one another through signal lines.

Communication of the re-encryption key generation device 500 is performed using the communication device 504.

Input and output of the re-encryption key generation device 500 is performed using the input/output interface 505.

The re-encryption key generation device 500 includes elements such as a reception unit 510, a re-encryption key generation unit 520, and an output unit 530. These elements are implemented by software.

The auxiliary storage device 503 stores a re-encryption key generation program for causing the computer to function as the reception unit 510, the re-encryption key generation unit 520, and the output unit 530. The re-encryption key generation program is loaded into the memory 502 and executed by the processor 501.

While executing the OS, the processor 501 executes the re-encryption key generation program.

Input and output data of the re-encryption key generation program is stored in a storage unit 590.

The re-encryption key generation program can be recorded (stored) in a non-volatile recording medium such as an optical disc or a flash memory, in a computer readable format.

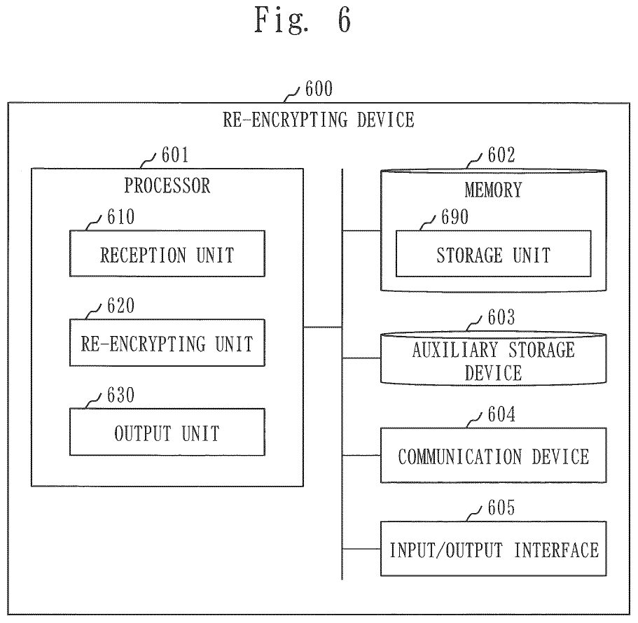

A configuration of the re-encrypting device 600 will be described based on FIG. 6.

The re-encrypting device 600 is a computer that includes pieces of hardware such as a processor 601, a memory 602, an auxiliary storage device 603, a communication device 604, and an input/output interface 605. These pieces of hardware are connected with one another through signal lines.

Communication of the re-encrypting device 600 is performed using the communication device 604.

Input and output of the re-encrypting device 600 is performed using the input/output interface 605.

The re-encrypting device 600 includes elements such as a reception unit 610, a re-encrypting unit 620, and an output unit 630. These elements are implemented by software.

The auxiliary storage device 603 stores a re-encrypting program for causing the computer to function as the reception unit 610, the re-encrypting unit 620, and the output unit 630. The re-encrypting program is loaded into the memory 602 and executed by the processor 601.

While executing the OS, the processor 601 executes the re-encrypting program.

Input and output data of the re-encrypting program is stored in a storage unit 690.

The re-encrypting program can be recorded (stored) in a non-volatile recording medium such as an optical disc or a flash memory, in a computer readable format.

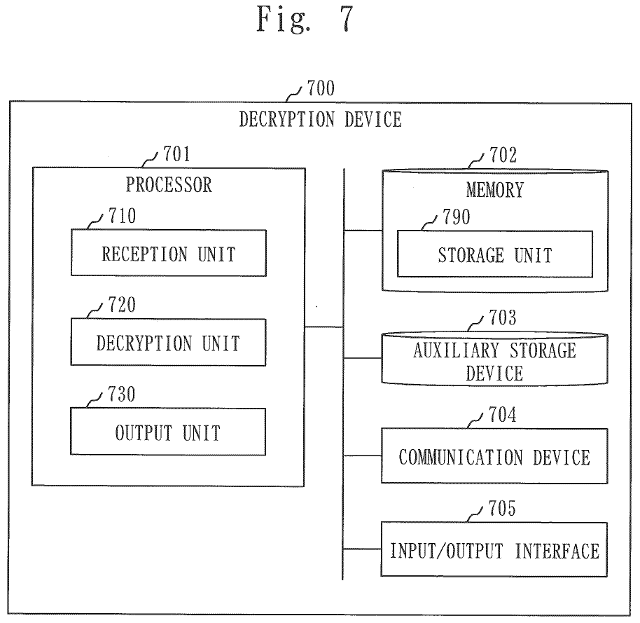

A configuration of the decryption device 700 will be described based on FIG. 7.

The decryption device 700 is a computer that includes pieces of hardware such as a processor 701, a memory 702, an auxiliary storage device 703, a communication device 704, and an input/output interface 705. These pieces of hardware are connected with one another through signal lines.

Communication of the decryption device 700 is performed using the communication device 704.

Input and output of the decryption device 700 is performed using the input/output interface 705.

The decryption device 700 includes elements such as a reception unit 710, a decryption unit 720, and an output unit 730. These elements are implemented by software.

The auxiliary storage device 703 stores a decryption program for causing the computer to function as the reception unit 710, the decryption unit 720, and the output unit 730. The decryption program is loaded into the memory 702 and executed by the processor 701.

While executing the OS, the processor 701 executes the decryption program.

Input and output data of the decryption program is stored in a storage unit 790.

The decryption program can be recorded (stored) in a non-volatile recording medium such as an optical disc or a flash memory, in a computer readable format.

### Description of Operation

A procedure of operation of the encryption system 100 is equivalent to an encryption method. Further, the procedure of the operation of the encryption system 100 is equivalent to a procedure of processing by the encryption program.

A procedure of operation of the parameter generation device 200 is equivalent to a parameter generation method. Further, the procedure of the operation of the parameter generation device 200 is equivalent to a procedure of processing by the parameter generation program.

A procedure of operation of the key generation device 300 is equivalent to a key generation method. Further, the procedure of the operation of the key generation device 300 is equivalent to a procedure of processing by the key generation program.

A procedure of operation of the encrypting device 400 is equivalent to an encrypting method. Further, the procedure of the operation of the encrypting device 400 is equivalent to a procedure of processing by the encrypting program.

A procedure of operation of the re-encryption key generation device 500 is equivalent to a re-encryption key generation method. Further, the procedure of the operation of the re-encryption key generation device 500 is equivalent to a procedure of processing by the re-encryption key generation program.

A procedure of operation of the re-encrypting device 600 is equivalent to a re-encrypting method. Further, the procedure of the operation of the re-encrypting device 600 is equivalent to a procedure of processing by the re-encrypting program.

A procedure of operation of the decryption device 700 is equivalent to a decryption method. Further, the procedure of the operation of the decryption device 700 is equivalent to a procedure of processing by the decryption program.

The encryption method includes the parameter generation method, the key generation method, the encrypting method, the re-encryption key generation method, the re-encrypting method, and the decryption method.

The encryption program includes the parameter generation program, the key generation program, the encrypting program, the re-encryption key generation program, the re-encrypting program, and the decryption program.

The following relations hold true in the encryption method.
M=DEC(SK, C)
RANDM(R, M)=DEC(RANDSKEY(R, SK), C)=DEC(SK, RANDCT(R, C))

“DEC” represents a decryption algorithm of public key encryption. M=DEC(SK, C) means outputting a plaintext M by taking a secret key SK and a ciphertext C as inputs, for example.

“RANDM” represents a plaintext randomization algorithm. RANDM(R, M) means randomizing the plaintext M using a random number R, for example.

“RANDSKEY” represents a key randomization algorithm. RANDSKEY(R, SK) means randomizing the secret key SK using the random number R, for example.

“RANDCT” represents a ciphertext randomization algorithm. RANDCT(R, C) means randomizing the cyphertext C using the random number R, for example.

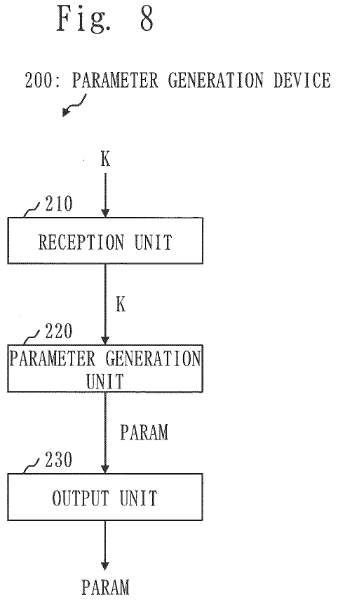

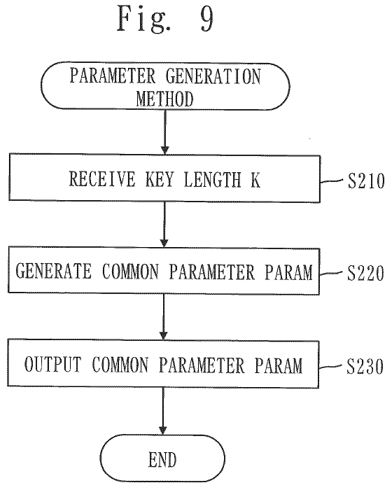

The parameter generation method will be described based on FIGS. 8 and 9.

FIG. 8 illustrates a functional configuration of the parameter generation device 200.

FIG. 9 illustrates a flowchart of the parameter generation method.

In step S210, the reception unit 210 receives a key length K. The key length K indicates a bit length.

An administrator inputs the key length K into the parameter generation device 200, and the reception unit 210 receives the inputted key length K, for example.

The key length K is information for generating a common parameter PARAM, and ultimately becomes a part of the common parameter PARAM.

In step S220, the parameter generation unit 220 generates the common parameter PARAM.

The common parameter PARAM is a parameter that serves as the basis for calculations in the encryption method. In other words, the common parameter PARAM is a parameter used for encryption. An example of the common parameter PARAM is an elliptical curve parameter used for elliptic curve encryption.

The parameter generation unit 220 generates a random number, and generates the common parameter PARAM using the random number, for example.

In step S230, the output unit 230 outputs the common parameter PARAM.

The output unit 230 sends the common parameter PARAM to the plurality of key generation devices 300, for example. The output unit 230 may also send the common parameter PARAM to the plurality of key generation devices 300, the plurality of encrypting devices 400, the re-encryption key generation device 500, the re-encrypting device 600, and the decryption device 700.

The common parameter PARAM may be delivered to each device by a manual method such as mail.

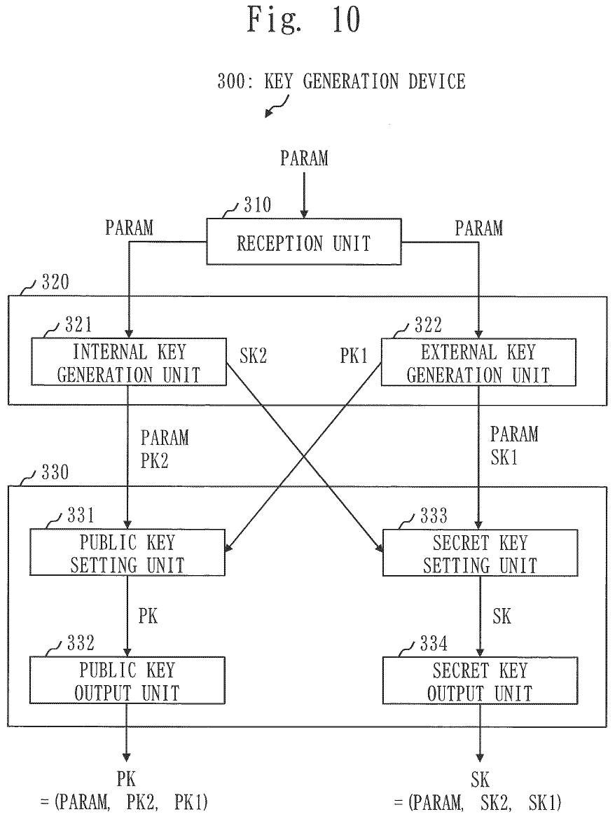

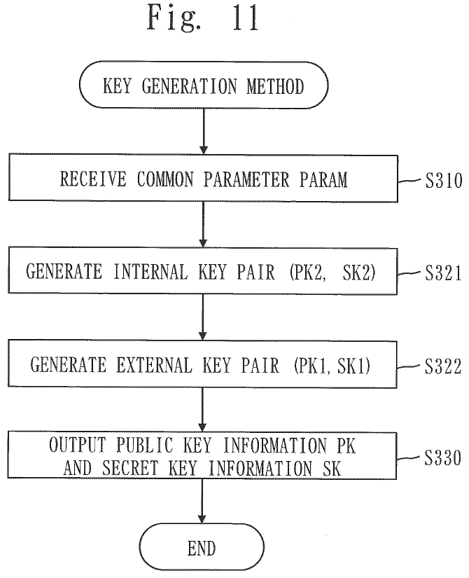

The key generation method will be described based on FIGS. 10 and 11.

FIG. 10 illustrates a functional configuration of the key generation device 300.

A key generation unit 320 includes elements such as the internal key generation unit 321 and the external key generation unit 322.

The output unit 330 includes elements such as a public key setting unit 331, a public key output unit 332, a secret key setting unit 333, and a secret key output unit 334.

FIG. 11 illustrates a flowchart of the key generation method.

Each of the plurality of the key generation devices 300 implements the key generation method.

In step S310, the reception unit 310 receives the common parameter PARAM.

The reception unit 310 receives the common parameter PARAM that is sent from the parameter generation device 200, for example.

In step S321, the internal key generation unit 321 generates an internal key pair using the common parameter PARAM.

The internal key pair is a pair of an internal public key PK2 and an internal secret key SK2.

The internal public key PK2 is a public key used for internal encryption.

The internal secret key SK2 is a secret key used for internal encryption.

Internal encryption means internal encryption (encryption at the first layer, encryption at the first round, and preliminary encryption) in double encryption.

The internal key pair (PK2, SK2) is represented as follows.
(PK2, SK2)=KG2(PARAM)

“KG2” represents a key generation algorithm of public key encryption (PKE).

When the key generation algorithm KG2 is executed by taking the common parameter PARAM as an input, the key generation algorithm KG2 outputs the internal key pair (PK2, SK2).

In step S322, the external key generation unit 322 generates an external key pair using the common parameter PARAM.

The external key pair is a pair of an external public key PK1 and an external secret key SK1.

The external public key PK1 is a public key used for external encryption.

The external secret key SK1 is a secret key used for external encryption.

External encryption means external encryption (encryption at the second layer, encryption at the second round, and later encryption) in double encryption.

The external key pair (PK1, SK1) is represented as follows.
(PK1, SK1)=KG1(PARAM)

“KG1” represents a key generation algorithm of public key encryption.

When the key generation algorithm KG1 is executed by taking the common parameter PARAM as an input, the key generation algorithm KG1 outputs the external key pair (PK1, SK1).

The key generation algorithm KG1 may be the same as the key generation algorithm KG2 or may be different from the key generation algorithm KG2.

Steps S321 and S322 may be executed in reverse order or may be executed concurrently.

In step S330, the output unit 330 outputs public key information PK and secret key information SK.

The output unit 330 sends the public key information PK to either the encrypting device 400 or the re-encryption key generation device 500, for example.

The output unit 330 sends the secret key information SK to the re-encryption key generation device 500 and the decryption device 700, for example.

The public key information PK includes the common parameter PARAM, the internal public key PK2, and the external public key PK1.

The secret key information SK includes the common parameter PARAM, the internal secret key SK2, and the external secret key SK1.

The public key information PK and the secret key information SK are represented as follows.
PK=(PARAM, PK2, PK1)
SK=(PARAM, SK2, SK1)

The public key information PK and the secret key information SK are outputted as follows.

The public key setting unit 331 generates the public key information PK using the common parameter PARAM, the internal public key PK2, and the external public key PK1. The public key output unit 332 outputs the public key information PK.

The secret key setting unit 333 generates the secret key information SK using the common parameter PARAM, the internal secret key SK2, and the external secret key SK1. The secret key output unit 334 outputs the secret key information SK.

Each of the public key information PK and the secret key information SK may not include the common parameter PARAM. In such a case, the common parameter PARAM is sent from the parameter generation device 200 to each device, for example.

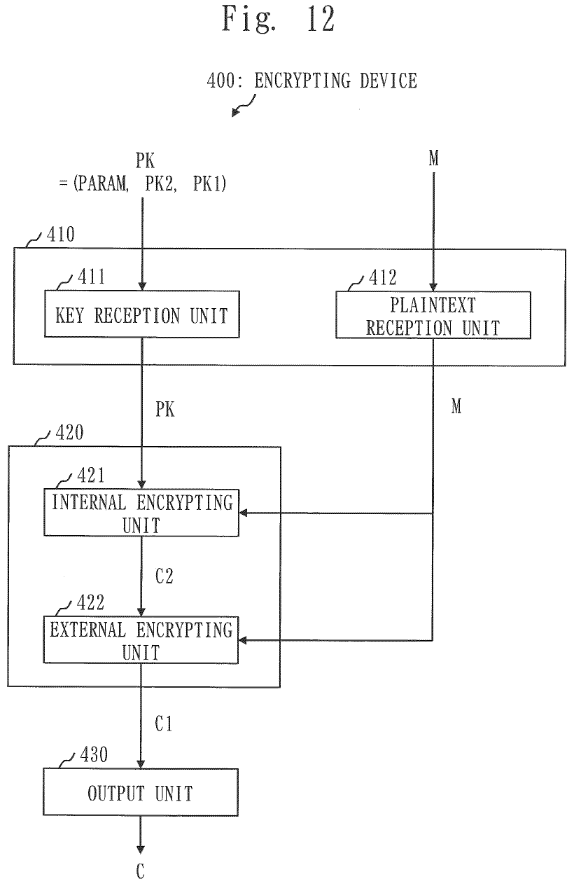

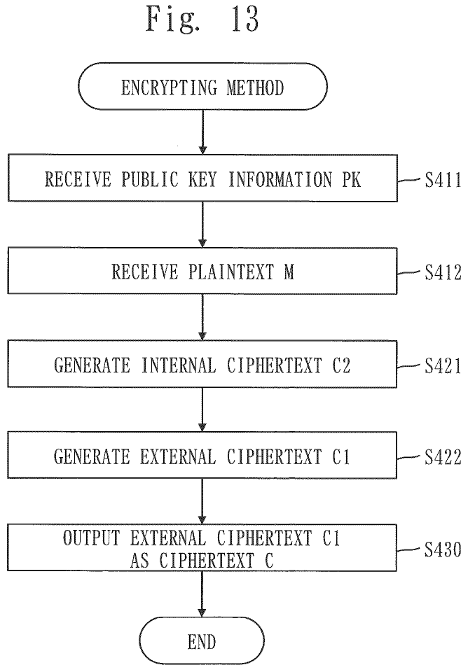

The encrypting method will be described based on FIGS. 12 and 13.

FIG. 12 illustrates a functional configuration of the encrypting device 400.

The reception unit 410 includes elements such as a key reception unit 411 and a plaintext reception unit 412.

The encrypting unit 420 includes elements such as an internal encrypting unit 421 and an external encrypting unit 422.

FIG. 13 illustrates a flowchart of the encrypting method.

Each of the plurality of encrypting devices 400 implements the encrypting method.

In step S411, the key reception unit 411 receives the public key information PK.

The key reception unit 411 receives the public key information PK that is sent from any of the key generation devices 300, for example.

In step S412, the plaintext reception unit 412 receives the plaintext M.

A user inputs the plaintext M into the encrypting device 400, and the plaintext reception unit 412 receives the inputted plaintext M, for example.

Steps S411 and S412 may be executed in reverse order or may be executed concurrently.

In step S421, the internal encrypting unit 421 encrypts the plaintext M using the internal public key PK2. The ciphertext generated in this manner is referred to as an internal ciphertext C2.

The internal encrypting unit 421 may generate a random number, and may use the random number for encryption.

The internal ciphertext C2 is represented as follows.
C2=ENC2(PK2, M)

“ENC2” represents an encryption algorithm of public key encryption.

When the encryption algorithm ENC2 is executed by taking the internal public key PK2 and the plaintext M as inputs, the encryption algorithm ENC2 outputs the internal ciphertext C2.

In step S422, the external encrypting unit 422 encrypts the internal ciphertext C2 using the external public key PK1. The ciphertext generated in this manner is referred to as an external ciphertext C1.

The external encrypting unit 422 may generate a random number, and may use the random number for encryption.

The external ciphertext C1 is represented as follows.
C1=ENC1(PK1, C2)

“ENC1” represents an encryption algorithm of public key encryption.

When the encryption algorithm ENC1 is executed by taking the external public key PK1 and the internal ciphertext C2 as inputs, the encryption algorithm ENC1 outputs the external ciphertext C1.

The encryption algorithm ENC1 may be the same as the encryption algorithm ENC2, or may be different from the encryption algorithm ENC2.

In step S430, the output unit 430 outputs the external ciphertext C1 as the ciphertext C for the plaintext M.

The output unit 430 sends the ciphertext C to the re-encrypting device 600 and the decryption device 700, for example.

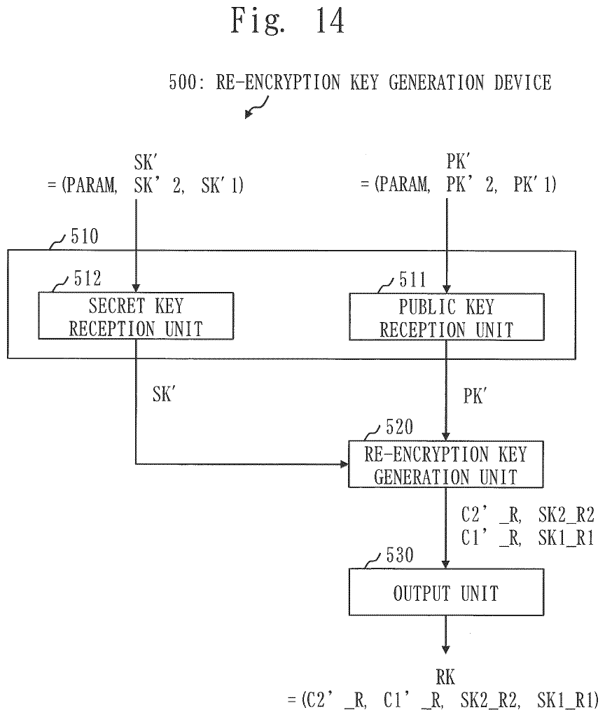

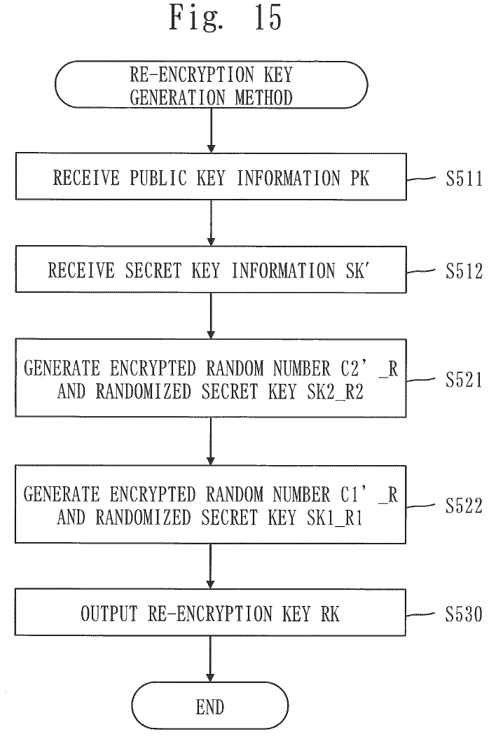

The re-encryption key generation method will be described based on FIGS. 14 and 15.

FIG. 14 illustrates a functional configuration of the re-encryption key generation device 500.

The reception unit 510 includes elements such as a public key reception unit 511 and a secret key reception unit 512.

FIG. 15 illustrates a flowchart of the re-encryption key generation method.

In step S511, the public key reception unit 511 receives public key information PK′.

The public key information PK′ is the public key information PK at a re-encryption destination.

The public key reception unit 511 receives the public key information PK that is sent from the key generation device 300 which is the re-encryption destination, for example.

The external public key PK1 included in the public key information PK′ is referred to as an external public key PK′1.

The internal public key PK2 included in the public key information PK′ is referred to as an internal public key PK′2.

In step S512, the secret key reception unit 512 receives secret key information SK′.

The secret key information SK′ is the secret key information SK at a re-encryption source.

The secret key reception unit 512 receives the secret key information SK that is sent from the key generation device 300 which is the re-encryption source, for example.

The external secret key SK1 included in the secret key information SK′ is referred to as an external secret key SK′1.

The internal secret key SK2 included in the secret key information SK′ is referred to as an internal secret key SK′2.

Steps S511 and S512 may be executed in reverse order or may be executed concurrently.

In step S521, the re-encryption key generation unit 520 generates a random number R2.

Then, the re-encryption key generation unit 520 encrypts the random number R2 using the internal public key PK′2. The encrypted random number generated in this manner is referred to as an encrypted random number C2′_R.

The encrypted random number C2′_R is represented as follows.
C2′_R=ENC2(PK′2, R2)

When the encryption algorithm ENC2 is executed by taking the internal public key PK′2 and the random number R2 as inputs, the encryption algorithm ENC2 outputs the encrypted random number C2′_R.

Further, the re-encryption key generation unit 520 randomizes the internal secret key SK′2 using the random number R2. The randomized secret key generated in this manner is referred to as a randomized secret key SK2_R2.

The randomized secret key SK2_R2 is represented as follows.
SK2_R2=RANDSKEY(SK′2, R2)

“RANDSKEY” represents a key randomization algorithm. The key randomization algorithm randomizes a key by multiplying a random number to the key, for example.

When the key randomization algorithm RANDSKEY is executed by taking the internal secret key SK′2 and the random number R2 as inputs, the key randomization algorithm RANDSKEY outputs the randomized secret key SK2_R2.

In step S522, the re-encryption key generation unit 520 generates a random number R1.

Then, the re-encryption key generation unit 520 encrypts the random number R1 using the external public key PK′1. The encrypted random number generated in this manner is referred to as an encrypted random number C1′_R.

The encrypted random number C1′_R is represented as follows.
C1′_R=ENC2(PK′1, R1)

When the encryption algorithm ENC2 is executed by taking the internal public key PK′1 and the random number R1 as inputs, the encryption algorithm ENC2 outputs the encrypted random number C1′_R.

Further, the re-encryption key generation unit 520 randomizes the external secret key SK′1 using the random number R1. The randomized secret key generated in this manner is referred to as a randomized secret key SK1_R1.

The randomized secret key SK1_R1 is represented as follows.
SK1_R1=RANDSKEY(SK′1, R1)

When the key randomization algorithm RANDSKEY is executed by taking the external secret key SK′1 and the random number R1 as inputs, the key randomization algorithm RANDSKEY outputs the randomized secret key SK1_R1.

Step S521 and step S522 may be executed in reverse order or may be executed concurrently.

In step S530, the output unit 530 outputs a re-encryption key RK.

The output unit 530 sends the re-encryption key RK to the re-encrypting device 600, for example.

The re-encryption key RK is represented as follows.
RK=(C2′_R, C1′_R, SK2_R2, SK1_R1)

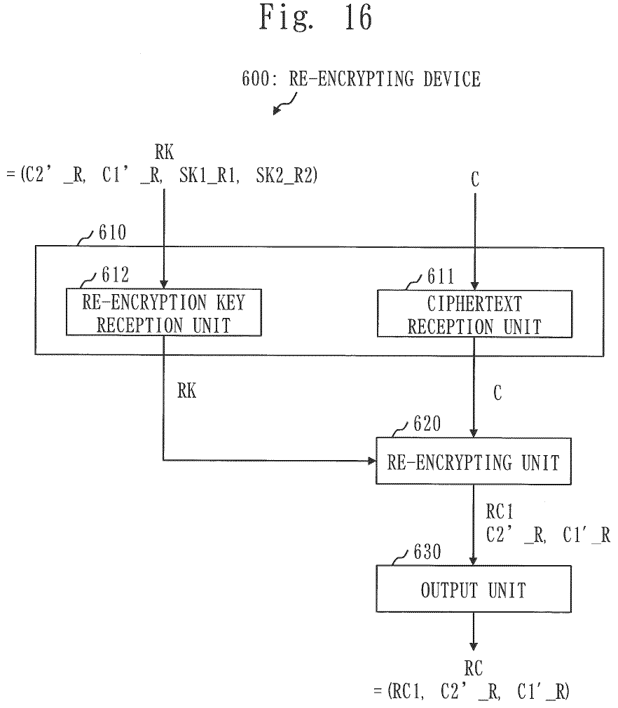

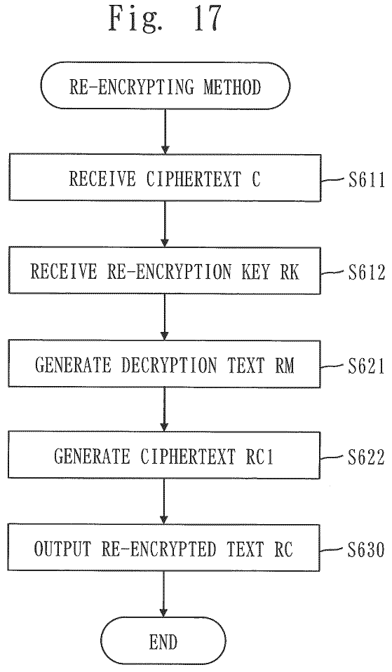

The re-encrypting method will be described based on FIGS. 16 and 17.

FIG. 16 illustrates a functional configuration of the re-encrypting device 600.

The reception unit 610 includes elements such as a ciphertext reception unit 611 and a re-encryption key reception unit 612.

FIG. 17 illustrates a flowchart of the re-encrypting method.

In step S611, the ciphertext reception unit 611 receives the ciphertext C.

The ciphertext reception unit 611 receives the ciphertext C that is sent from any of the encrypting devices 400, for example.

In step S612, the re-encryption key reception unit 612 receives the re-encryption key RK.

The re-encryption key reception unit 612 receives the re-encryption key RK that is sent from the re-encryption key generation device 500, for example.

Steps S611 and S612 may be executed in reverse order or may be executed concurrently.

In step S621, the re-encrypting unit 620 decrypts the ciphertext C using the randomized secret key SK1_R1. The decryption text obtained in this manner is referred to as a decryption text RCT1.

The decryption text RCT1 is represented as follows.
RCT1=DEC1(SK1_R1, C)=RANDCT(R1, ENC2(PK2, M))

“DEC1” represents a decryption algorithm of public key encryption.

When the decryption algorithm DEC1 is executed by taking the randomized secret key SK1_R1 and the ciphertext C as inputs, the decryption algorithm DEC1 outputs the decryption text RCT1.

“RANDCT” represents a ciphertext randomization algorithm. The ciphertext randomization algorithm is an algorithm that uses a random number to randomize a ciphertext.

Further, the re-encrypting unit 620 decrypts the decryption text RCT1 using the randomized secret key SK2_R2. The decryption text obtained in this manner is referred to as a decryption text RM.

The decryption text RM is represented as follows.
RM=DEC1(SK2_R2, RCT1)=RANDCT(R1, RANDCT(R2, M))

When the decryption algorithm DEC1 is executed by taking the randomized secret key SK2_R2 and the decryption text RCT1 as inputs, the decryption algorithm DEC1 outputs the decryption text RM.

In step S622, the re-encrypting unit 620 encrypts the decryption text RM using the internal public key PK′2. The ciphertext generated in this manner is referred to as a ciphertext RM.

Then, the re-encrypting unit 620 encrypts the ciphertext RM using the external public key PK′1. The ciphertext generated in this manner is referred to as a ciphertext RC1.

The ciphertext RC1 is represented as follows.
RC1=ENC1(PK′1, ENC2(PK′2, RM))

In step S630, the output unit 630 outputs a re-encrypted text RC.

The output unit 630 sends the re-encrypted text RC to the decryption device 700, for example.

The re-encrypted text RC is represented as follows.
RC=(RC1, C2′_R, C1′_R)

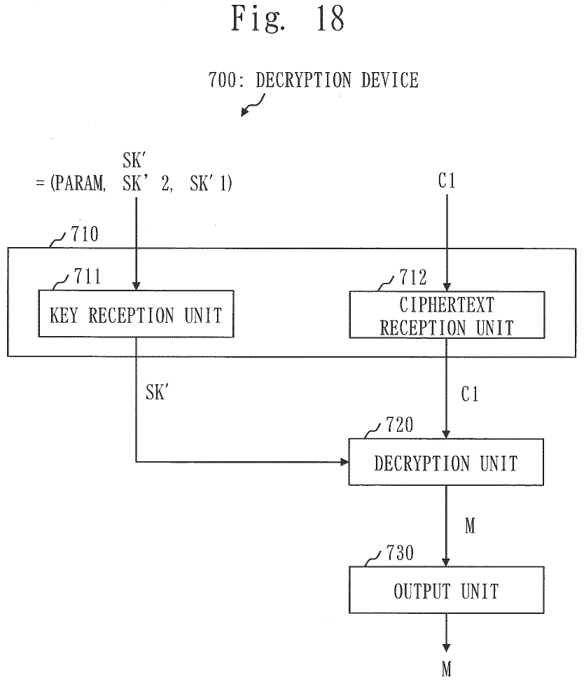

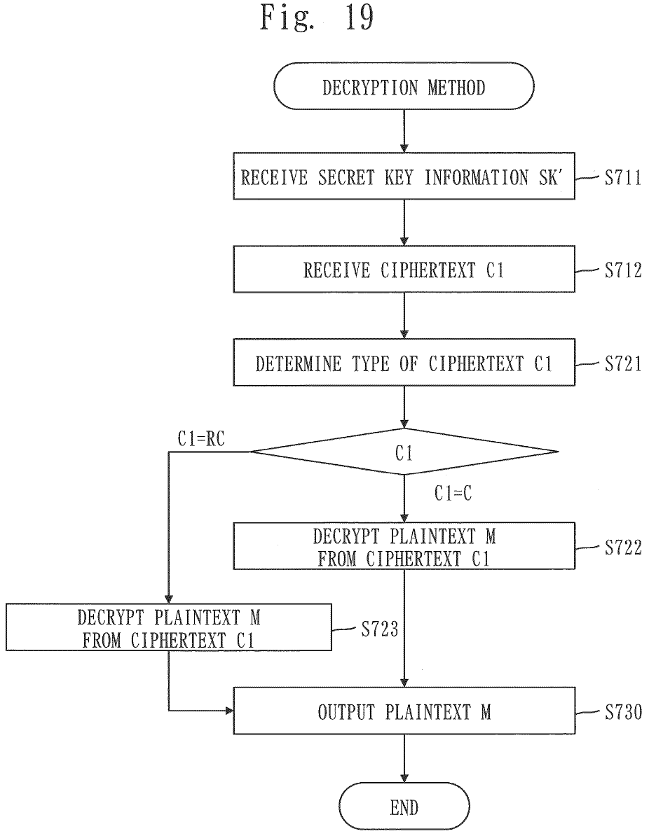

The decryption method will be described based on FIGS. 18 and 19.

FIG. 18 illustrates a functional configuration of the decryption device 700.

The reception unit 710 includes elements such as a key reception unit 711 and a ciphertext reception unit 712.

FIG. 19 illustrates a flowchart of the decryption method.

In step S711, the key reception unit 711 receives the secret key information SK′.

The key reception unit 711 receives the secret key information SK that is sent from any of the key generation devices 300, as the secret key information SK′, for example.

In step S712, the ciphertext reception unit 712 receives the ciphertext C1.

The ciphertext C1 is either the ciphertext C or the re-encrypted text RC.

The ciphertext reception unit 712 receives either the ciphertext C that is sent from the encrypting device 400 or the re-encrypted text RC that is sent from the re-encrypting device 600, for example.

Steps S711 and S712 may be executed in reverse order or may be executed concurrently.

In step S721, the decryption unit 720 determines the type of the ciphertext C1.

The type of the ciphertext C1 is determined based on the size or the like of the ciphertext C1.

When the ciphertext C1 is the ciphertext C, the process proceeds to step S722.

When the ciphertext C1 is the re-encrypted text RC, the process proceeds to step S723.

In step S722, the decryption unit 720 decrypts the plaintext M from the ciphertext C1 using the external secret key SK′1 and the internal secret key SK′2.

The plaintext M is represented as follows.
M=DEC(SK′2, DEC(SK′1, C1))

“DEC” represents a decryption algorithm of public key encryption. The decryption algorithm is an algorithm that takes a secret key and a ciphertext as inputs and outputs a decryption text.

In step S723, the ciphertext C1 is the re-encrypted text RC=(RC1, C2′_R, C1′_R).

The decryption unit 720 decrypts the random number R2 from the encrypted random number C2′_R using the internal secret key SK′2.

Further, the decryption unit 720 decrypts the random number R1 from the encrypted random number C1′_R using the external secret key SK′1.

Further, the decryption unit 720 decrypts the ciphertext RC1 using the external secret key SK′1. The decryption text obtained in this manner is referred to as a decryption text RC1.

Furthermore, the decryption unit 720 decrypts the decryption text RM from decryption text RC1 using the internal secret key SK′2.

The random number R2, the random number R1, and the decryption text RM are represented as follows.
R2=DEC(SK′2, C2′_R)
R1=DEC(SK′1, C1′_R)
RM=DEC(SK′2, DEC(SK′1, RC1))

Then, the decryption unit 720 calculates the plaintext M using the random number R2, the random number R1, and the decryption text RM.

The plaintext M is calculated by calculating an inverse function of the ciphertext randomization algorithm RANDCT using the random number R2, the random number R1, and the decryption text RM.

After step S722 or step S723, the process proceeds to step S730.

In step S730, the output unit 730 outputs the plaintext M.

### Summary of Embodiment 1

The encryption system 100 includes the parameter generation device 200, the plurality of key generation devices 300, the plurality of encrypting devices 400, the re-encryption key generation device 500, the re-encrypting device 600 and the decryption device 700.

The parameter generation device 200 generates a commonly used parameter by taking a bit length or the like of a key to be used, as an input.

The key generation device 300 generates a public key and a secret key for both of internal and external encryption by taking the parameter as an input.

The encrypting device 400 generates an original ciphertext taking the public key as an input.

The re-encryption key generation device 500 generates a re-encryption key by taking a public key at a re-encryption destination and a secret key at a re-encryption source, as inputs. The re-encryption key serves as a key to convert a ciphertext without decrypting the ciphertext.

The re-encrypting device 600 takes the ciphertext and the re-encryption key as inputs, and outputs the re-encrypted ciphertext. In other words, the re-encrypting device 600 modifies only the internal public key without decrypting the ciphertext, and converts the ciphertext into a ciphertext at a new destination.

The decryption device 700 takes the ciphertext and the secret key as inputs, and outputs a decryption result.

### Effects of Embodiment 1

Embodiment 1 is an embodiment in which a ciphertext is re-encrypted without decrypting the ciphertext. In re-encryption, a different key is used to realize encryption.

Embodiment 1 is an embodiment that relates to double encryption. In double encryption, a plaintext is first encrypted using Method 1, then encrypted using Method 2.

In Embodiment 1, only a key for Method 1 is modified. Thereby, it is possible to deal with various security risks, such as only a key for Method 2 being compromised.

Embodiment 1 proposes a method that modifies a key for an internal encryption method while leaving a key for an external encryption method unmodified, in double encryption using different encryption methods.

Thereby, the security of the double encryption is improved. Specifically, it is possible to modify the key in an efficient and secure manner.

In Embodiment 1, when a plaintext is double encrypted, each of a secret key used for internal encryption and a secret key used for external encryption is randomized, and a re-encryption key is generated.

Thereby, re-encryption can be realized without decryption, in double encryption. As a result, it is possible to modify the key in a safer and more efficient manner.

### Supplements to Embodiment 1

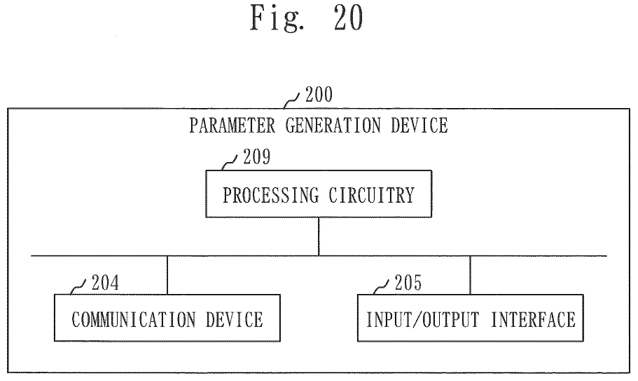

A hardware configuration of the parameter generation device 200 will be described based on FIG. 20.

The parameter generation device 200 includes processing circuitry 209.

The processing circuitry 209 is a piece of hardware that implements the reception unit 210, the parameter generation unit 220, and the output unit 230.

The processing circuitry may be dedicated hardware, or may be a processor that executes programs stored in the memory.

When the processing circuitry is the dedicated hardware, the processing circuitry is, for example, a single circuit, a compound circuit, a programmed processor, a parallel programmed processor, an ASIC, an FPGA, or a combination of these.

ASIC is an abbreviation for Application Specific Integrated Circuit.

FPGA is an abbreviation for Field Programmable Gate Array.

The parameter generation device 200 may include a plurality of pieces of processing circuitry as an alternative to the processing circuitry 209.

In the processing circuitry, some functions may be implemented by the dedicated hardware, and the remaining functions may be implemented by software or firmware.

In such a manner, a function of the parameter generation device 200 can be implemented by hardware, software, firmware, or a combination of these.

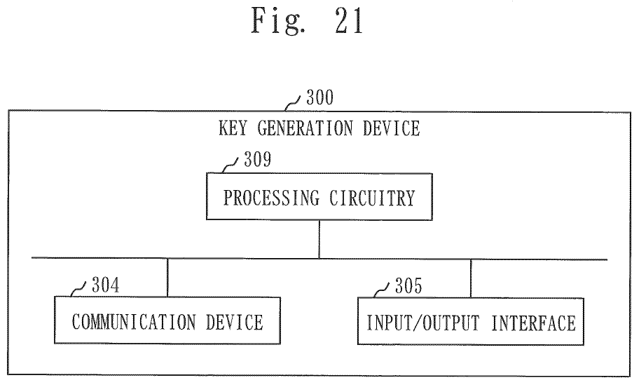

A hardware configuration of the key generation device 300 will be described based on FIG. 21.

The key generation device 300 includes processing circuitry 309.

The processing circuitry 309 is a piece of hardware that implements the reception unit 310, the key generation unit 320, and the output unit 330.

The key generation device 300 may include a plurality of pieces of processing circuitry as an alternative to the processing circuitry 309.

A function of the key generation device 300 can be implemented by hardware, software, firmware, or a combination of these.

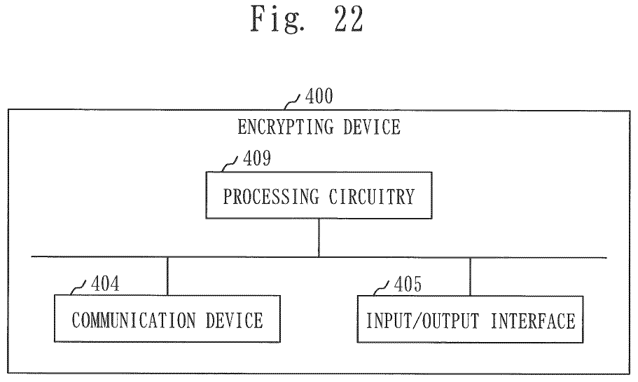

A hardware configuration of the encrypting device 400 will be described based on FIG. 22.

The encrypting device 400 includes processing circuitry 409.

The processing circuitry 409 is a piece of hardware that implements the reception unit 410, the encrypting unit 420, and the output unit 430.

The encrypting device 400 may include a plurality of pieces of processing circuitry as an alternative to the processing circuitry 409.

A function of the encrypting device 400 can be implemented by hardware, software, firmware, or a combination of these.

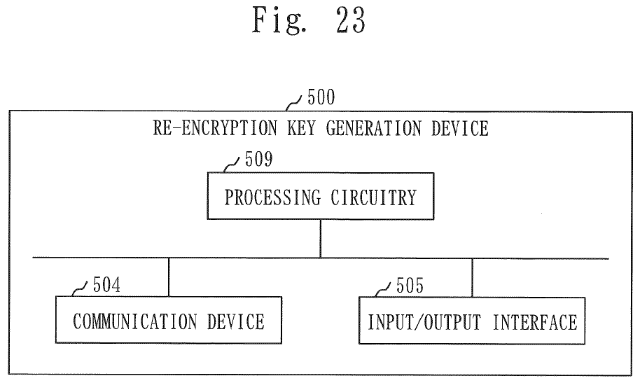

A hardware configuration of the re-encryption key generation device 500 will be described based on FIG. 23.

The re-encryption key generation device 500 includes processing circuitry 509.

The processing circuitry 509 is a piece of hardware that implements the reception unit 510, the re-encryption key generation unit 520, and the output unit 530.

The re-encryption key generation device 500 may include a plurality of pieces of processing circuitry as an alternative to the processing circuitry 509.

A function of the re-encryption key generation device 500 can be implemented by hardware, software, firmware, or a combination of these.

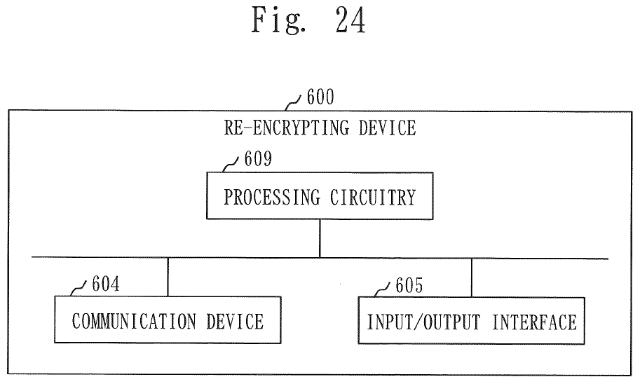

A hardware configuration of the re-encrypting device 600 will be described based on FIG. 24.

The re-encrypting device 600 includes processing circuitry 609.

The processing circuitry 609 is a piece of hardware that implements the reception unit 610, the re-encrypting unit 620, and output unit 630.

The re-encrypting device 600 may include a plurality of pieces of processing circuitry as an alternative to the processing circuitry 609.

A function of the re-encrypting device 600 can be implemented by hardware, software, firmware or a combination of these.

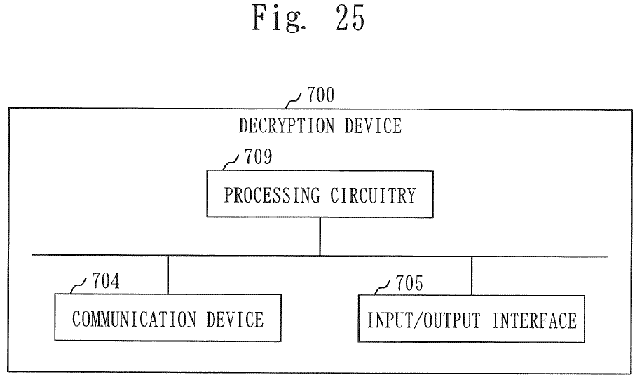

A hardware configuration of the decryption device 700 will be described based on FIG. 25.

The decryption device 700 includes processing circuitry 709.

The processing circuitry 709 is a piece of hardware that implements the reception unit 710, the decryption unit 720, and the output unit 730.

The decryption device 700 may include a plurality of pieces of processing circuitry as an alternative to the processing circuitry 709.

A function of the decryption device 700 can be implemented by hardware, software, firmware, or combinations of these.

Embodiment 1 is an example of a preferred embodiment and is not intended to limit the technical scope of the present disclosure. Embodiment 1 may be implemented partially, or may be implemented in combination with another embodiment. The procedures described using the flowcharts or the like may be suitably modified.

“Unit” of each element of each device in the encryption system 100 may be read or interpreted as “process”, “step”, “circuit” or “circuitry”.

In the following, the embodiments of the present disclosure will be described with the reference signs used in Embodiment 1 indicated in parentheses.

An encryption system (100) includes:
an encrypting device (400) to generate a ciphertext (C) by double encrypting a plaintext (M) using a first internal public key (PK2) and a first external public key (PK1);
a re-encryption key generation device (500) to generate a randomized internal secret key (SK2_R2) by randomizing a first internal secret key (SK′2) using a second random number (R2), to generate a second encrypted random number (C2′_R) by encrypting the second random number (R2) using a second internal public key (PK′2), to generate a randomized external secret key (SK1_R1) by randomizing a first external secret key (SK′1) using a first random number (R1), and to generate a first encrypted random number (C1′_R) by encrypting the first random number (R1) using a second external public key (PK′1);
a re-encrypting device (600) to obtain a randomized decryption text (RM) by decrypting the ciphertext (C) using the randomized external secret key (SK1_R1) and the randomized internal secret key (SK2_R2), and to generate a re-encrypted text (RC1) by encrypting the randomized decryption text (RM) using the second internal public key (PK′2) and the second external public key (PK′1); and
a decryption device (700) to decrypt the second random number (R2) from the second encrypted random number (C2′_R) using the second internal secret key (SK′2), to decrypt the first random number (R1) from the first encrypted random number (C1′_R) using the second external secret key (SK′1), to decrypt the randomized decryption text (RM) from the re-encrypted text (RC1) using the second external secret key (SK′1) and the second internal secret key (SK′2), and to calculate the plaintext (M) using the randomized decryption text (RM), the second random number (R2), and the first random number (R1).

### REFERENCE SIGNS LIST

100: encryption system; 101: network; 200: parameter generation device; 201: processor; 202: memory; 203: auxiliary storage device; 204: communication device; 205: input/output interface; 209: processing circuitry; 210: reception unit; 220: parameter generation unit; 230: output unit; 290: storage unit; 300: key generation device; 301: processor; 302: memory; 303: auxiliary storage device; 304: communication device; 305: input/output interface; 309: processing circuitry; 310: reception unit; 320: key generation unit; 321: internal key generation unit; 322: external key generation unit; 330: output unit; 331: public key setting unit; 332: public key output unit; 333: secret key setting unit; 334: secret key output unit; 390: storage unit; 400: encrypting device; 401: processor; 402: memory; 403: auxiliary storage device; 404: communication device; 405: input/output interface; 409: processing circuitry; 410: reception unit; 411: key reception unit; 412: plaintext reception unit; 420: encrypting unit; 421: internal encrypting unit; 422: external encrypting unit; 430: output unit; 490: storage unit; 500: re-encryption key generation device; 501: processor; 502: memory; 503: auxiliary storage device; 504: communication device; 505: input/output interface; 509: processing circuitry; 510: reception unit; 511: public key reception unit; 512: secret key reception unit; 520: re-encryption key generation unit; 530: output unit; 590: storage unit; 600: re-encrypting device; 601: processor; 602: memory; 603: auxiliary storage device; 604: communication device; 605: input/output interface; 609: processing circuitry; 610: reception unit; 611: ciphertext reception unit; 612: re-encryption key reception unit; 620: re-encrypting unit; 630: output unit; 690: storage unit; 700: decryption device; 701: processor; 702: memory; 703: auxiliary storage device; 704: communication device; 705: input/output interface; 709: processing circuitry; 710: reception unit; 711: key reception unit; 712: ciphertext reception unit; 720: decryption unit; 730: output unit; 790: storage unit.

1. An encryption system comprising:
an encrypting device to generate a ciphertext by double encrypting a plaintext using a first internal public key and a first external public key;
a re-encryption key generation device to generate a randomized internal secret key by randomizing a first internal secret key using a second random number, to generate a second encrypted random number by encrypting the second random number using a second internal public key, to generate a randomized external secret key by randomizing a first external secret key using a first random number, and to generate a first encrypted random number by encrypting the first random number using a second external public key;
a re-encrypting device to obtain a randomized decryption text by decrypting the ciphertext using the randomized external secret key and the randomized internal secret key, and to generate a re-encrypted text by encrypting the randomized decryption text using the second internal public key and the second external public key; and
a decryption device to decrypt the second random number from the second encrypted random number using the second internal secret key, to decrypt the first random number from the first encrypted random number using the second external secret key, to decrypt the randomized decryption text from the re-encrypted text using the second external secret key and the second internal secret key, and to calculate the plaintext using the randomized decryption text, the second random number, and the first random number.

2. An encryption method comprising:
generating a ciphertext by double encrypting a plaintext using a first internal public key and a first external public key;
generating a randomized internal secret key by randomizing a first internal secret key using a second random number, generating a second encrypted random number by encrypting the second random number using a second internal public key, generating a randomized external secret key by randomizing a first external secret key using a first random number, and generating a first encrypted random number by encrypting the first random number using a second external public key;
obtaining a randomized decryption text by decrypting the ciphertext using the randomized external secret key and the randomized internal secret key, and generating a re-encrypted text by encrypting the randomized decryption text using the second internal public key and the second external public key; and
decrypting the second random number from the second encrypted random number using the second internal secret key, decrypting the first random number from the first encrypted random number using the second external secret key, decrypting the randomized decryption text from the re-encrypted text using the second external secret key and the second internal secret key, and calculating the plaintext using the randomized decryption text, the second random number, and the first random number.

3. A non-transitory computer readable medium storing an encryption program comprising:
an encrypting program for causing a computer to execute an encrypting process to generate a ciphertext by double encrypting a plaintext using a first internal public key and a first external public key;
a re-encryption key generation program for causing a computer to execute a re-encryption key generation process to generate a randomized internal secret key by randomizing a first internal secret key using a second random number, to generate a second encrypted random number by encrypting the second random number using a second internal public key, to generate a randomized external secret key by randomizing a first external secret key using a first random number, and to generate a first encrypted random number by encrypting the first random number using a second external public key;
a re-encrypting program for causing a computer to execute a re-encrypting process to obtain a randomized decryption text by decrypting the ciphertext using the randomized external secret key and the randomized internal secret key, and to generate a re-encrypted text by encrypting the randomized decryption text using the second internal public key and the second external public key; and
a decryption program for causing a computer to execute a decryption process to decrypt the second random number from the second encrypted random number using the second internal secret key, to decrypt the first random number from the first encrypted random number using the second external secret key, to decrypt the randomized decryption text from the re-encrypted text using the second external secret key and the second internal secret key, and to calculate the plaintext using the randomized decryption text, the second random number, and the first random number.
